(19) United States
(12) Patent Application Publication
(10) Pub. No.: US 2022/0333296 A1
(43) Pub. Date: Oct. 20, 2022

(54) NATURAL ANTIMICROBIAL FINISH ON FABRICS AND METHOD THEREOF

(71) Applicant: Kiruthika KANNAPPAN, Coimbatore (IN)

(72) Inventor: Kiruthika KANNAPPAN, Coimbatore (IN)

(21) Appl. No.: 17/753,567

(22) PCT Filed: Jan. 25, 2021
(86) PCT No.: PCT/IN2021/050076

§ 371 Date: Mar. 8, 2022

(30) Foreign Application Priority Data
Jan. 27, 2020 (IN) 202041003585

(51) Int. Cl. D06M 16/00; A01N 65/26; A01N 43/90; A01N 25/28; A01P 1/00; D06M 23/12

(52) U.S. Cl. CPC D06M 16/00; A01N 65/26; A01N 43/90; A01N 25/28; A01P 1/00; D06M 23/12

(57) ABSTRACT

The present invention relates to an anti-microbial finish on the fabrics. The present invention particularly relates to an antimicrobial microencapsulated fabric finish composition comprising Neem extract and Azadirachta derived from flower and fruits of Azadirachta indica. The invention relates an antimicrobial finish coat on fabrics, particularly Terry towels. Further the invention relates to method of finishing of fabric with antimicrobial composition of Azadiracta indica, to provide a durable and anti-microbial fabric, wherein the fabric is preferably terry towel and woven plain fabrics like sheetings and bed linen.

### FIELD OF THE INVENTION

The present invention relates to an anti-microbial finish on the fabrics. The present invention particularly relates to an antimicrobial composition of Azadirachta indica provided as an antimicrobial finish coat on fabrics, particularly Terry towels. Particularly the invention relates to method of finishing of fabric with antimicrobial composition of Azadirachta indica, to provide a durable and anti-microbial fabric, wherein the fabric is preferably terry towel and woven plain fabrics like sheetings and bed linen.

### BACKGROUND OF THE INVENTION

The textile fibers are these days increasingly treated with antimicrobial reagents. With the improvement of life standards, the demand of hygienic products is increasing for biocidal finishes in textiles (sports-wears, undergarment, bed-linen) and water filtration. The antibacterial finish treatment has become vital area of medical, surgical and healthcare activities due potential pathogenic microorganisms present in hospital environment and cause cross-infection diseases. The types of micro-organisms include different kinds of organisms such as virus, bacteria, unicellular plants and animals, certain algae and fungi. Classification in bacteria family is “gram positive, gram negative, spore bearing or non-spore bearing type”. Some of the bacteria are of pathogenic nature that may cause infections to human. A microbe (e.g. bacteria and fungus) normally protected with an outer cell wall that is composed of polysaccharides. The cell wall keeps up the veracity of cellular components and protects the cell from the extracellular situation; below the cell wall is a semi-permeable membrane that holds intracellular organelles, enzymes and nucleic acids. Chemical reactions within cell wall take place due to the enzymes present in cell wall. The nucleic acids hold the entire genetic directory of organisms.

The microorganisms responsible for microbial damage are generally present in surroundings; besides, formation of the substrates and the chemical processes may encourage growth of the microbes; further moist and warm environment still exaggerate the problem. A gram-positive bacterium contains peptidoglycan and teichoic acid, peptidoglycan comprises of 90% of cell walls and made of amino acid and sugar. One example of gram-positive bacteria is Staphylococcus aureus that is in form of pair, short chain or graphic like cluster. Its size range is 0.5 μm to 1.0 μm and grows in temperature range of 35 to 40° C. Staphylococcus aureus is major cause of cross infection in hospital environment and 19% of total surgical infection. It's also responsible for boils and also cause scaled skin infections. Other gram-positive bacteria are Staphylococcus epidermidis, Streptococcus pneumonia, Streptococcus pyogenes and Steptococcus viridians. The gram-negative bacteria are alike to gram positive bacteria apart from an outer layer of membrane affixed to peptidoglycan by lipoproteins which used to transport too low molecular weight substances.

Certain investigations on medicinal plants provide a clue that herbal drugs can be effectively utilized for identifying their additive or potentiating effects in appropriate areas. The present invention goes by this approach and seeks to explore the synergistic/potentiating or additive effects of medicinal plants to address the issue of bacterial resistance. The neem tree also referred as Azadirachta indica A. juss is known since ages for its healthcare benefits. The tree has been attributed with many therapeutic effects in various Ayurvedic texts and even the common-folk appear to have a fair understanding about its medicinal uses and therefore, they use it often, for such benefits. Mostly, the leaves, the seeds and their fixed oil portion and bark of neem are used for their medicinal activities. However, the leaves and bark are preferred for oral use in humans.

One of the common beliefs is that, various parts of neem are effective against infectious conditions. Based on these perceptions, various parts of neem have been investigated and the observations have been classified commonly as observations for antibacterial, anti-fungal and anti-viral conditions.

Similarly, neem seeds and seed oils have been examined in depth for their effect on agricultural pests. Eventually, seeds and seed oils have been picked up for development of natural pesticides. Several patents have been granted for insecticidal and fungicidal properties of neem seeds and oil. U.S. Pat. No. 4,943,434 teaches development of insecticidal compositions employing hydrogenated extracts obtained from neem seeds (Azadirachtin).

Patent No. IN278142B discloses an antimicrobial composition with Metal/Polymer, wherein the metal is silver and polymer is vinyl imidazole.

Patent Application number IN20192101890A discloses antimicrobial composition with Aloe vera/Fragrance prepared by means of micro encapsulation, applied by padding followed by curing to have durable washes and washed effects, sodium alginate is thickener.

Patent Application number WO2011/057536A1 discloses antimicrobial composition with blumea oil/wrinkle free micro encapsulation. Blumea with wrinkle free effect by microencapsulation using cross linking agent selected from formaldehyde, glyoxal or glutaldehyde or mixtures of glycols. Application involves dipping the fabric in the AM solution for padding followed by drying at 85 degree Celsius and curing at 180 degree Celsius.

Patent No. IN253898B—Process of inducing antimicrobial and anti-creasing property, discloses anti-creasing property using crosslinking agent followed by antimicrobial composition with neem extract and limonoid followed. Not 100% Natural, Natural neem extract combined with metals and organic compounds. Anti-creasing property using crosslinking agent, Activator and inorganic salts. Cross linking agent—Dimethyl dihydroxylethyelene urea (DMDHEUA), glyoxal, poly carboxylic acid such as citric acid, BTCA preferably glyoxal, usage 2 to 15%, DMDHEUA—contains Formaldehyde which is banned. Acid catalyst—Magnesium chloride, Aluminium sulfate, sodium bisulfate, or Zirconium sulfate—usage 1 to 0.8% total composition. Applied with both cotton and cotton/polyester blend. Hydrophobic finish. Antimicrobial chemical induced after anti-creasing agent. Antimicrobial chemical—neem extract 1.30% to 8.099% and limonoid 0.1% to 1.15%.

U.S. Pat. No. 9,220,275B2 discloses neem oil microencapsulated, two binder's poly siloxanes and poly urethanes as binders, neem oil composition—nimbin 1 to 30%, salanin—0.15%-20.0% and azadirachtin—0.15%-20%. Soaking the fabric with chemical dispersion two times before drying 30% loss after 3 washings.

Patent application number KR10040513961 discloses use of terpene oil and not neem based. Composition: 1. Terpene oil, poly vinyl chloride, styrene butadiene rubber, natural rubber, isocyanate melamine, silica powder etc. Not 100% natural, mode of application—by coating technique.

IJFTR Vol.32(3) [September 2007], Microencapsulation of herbal extracts for microbial resistance in health care textiles by Thilagavathi, GBala, S Krishna & T. Kannaian, discloses microencapsulated neem and Mexican daisy, Mexican daisy is also having antimicrobial property, Pad-dry-cure method.

Journal of Applied Polymer Science, Vol. 106, 793-800 (2007), Antibacterial Finishing of Polyester/Cotton Blend Fabrics Using Neem (Azadirachta indica): A Natural Bioactive Agent by Joshi, Washed Ali, & Rajendran, discloses cotton/polyester blend, polyester will exhibit antimicrobial property due to hydrophobic nature, extracts of neem tree and cross linking agent to bind on cotton/polyester blend, no claim on durability.

Int. J. Life Sci. Pharma Res. 2018 Oct; 8(4): (L) 10-20, Sustainable antimicrobial finishing of fabrics using natural bioactive agents—a review, A. Reshmal, V. BrindhaPriyadarisini, K. Amutha, discloses antimicrobial natural chemicals like basil, neem, aloevera, turmeric, clove oil, chitosan etc. No specific method of formulation and application.

International Journal of Innovative Research in Science, Engineering and Technology Vol. 2, Issue 6, Imparting antimicrobial finish by microencapsulation technique by Dr. S.K.Chinta, Ms.Pooja P. Wane, discloses imparting antimicrobial property by microencapsulation technique, it does not cover the specific application method and formulations, and it deals with application of cotton/synthetic blends.

Asian Pacific Journal of Tropical Medicine (2010) 3(2) 128-132, Antimicrobial activity of cotton and silk fabric with herbal extract by microencapsulation by Saraswathi, R., Krishnan, P. N., & Dilip C, antimicrobial property of cotton and silk, no specific claims on formulation, application and dosage etc.

Curr Trends Fashion Technol Textile Eng 4(5): CTFTTE.MS.ID.555646 (2019), Antimicrobial finishes for Textiles by Nadeem A, FaheemU,Uzma S, Arshad Mdcovers the review of natural antimicrobial property of herbals. No specific claims on formulation, application and dosage etc.

### OBJECT OF THE INVENTION

It is primary object of the present invention to provide a natural antimicrobial finish agent for fabrics.

It is another object of the present invention to provide a natural antimicrobial finish agent comprising neem extract and azadirachtin.

It is another object of the present invention to provide a natural treatment of resistant bacterial infections on fabric.

It is another object of the present invention to provide natural antimicrobial coating on fabric, particularly terry fabric or terry towels and further the method of antimicrobial coating.

### SUMMARY OF THE INVENTION

One or more of the problems of the conventional prior art may be overcome by various embodiments of the present invention.

Thus according to the basic aspect of the present invention there is provided a antimicrobial composition comprising of microencapsulated neem extract with 25% active content with 1% azadirachtin.

It is another aspect of the present invention to provide a method of finishing of fabric with the microencapsulated antimicrobial composition, comprising of steps:
desizing of the fabric;
scouring and half bleaching;
neutralization;
dyeing;
after treatment;
finishing with an antimicrobial composition;
softening; and
finishing,
   wherein the antimicrobial composition comprises of extract of Azadirachtin indica.

It is another aspect of the present invention to provide a fabric with insecticidal and mosquito repellent property.

It is another aspect of the present invention to provide an antimicrobial finish on the fabric.

It is another aspect of the present invention to provide an antimicrobial finish on the fabric, wherein the fabric is terry towel, woven plain fabrics like sheeting and bed linens and the like.

It is yet another aspect of the present invention to provide a durable antimicrobial composition as fabric finish comprising neem extract and azadirachtin.

It is yet another aspect of the present invention to provide an antimicrobial composition as fabric finish, wherein the neem extract is powder extract of leaf and flower of Azadirachta indica.

It is the main aspect of the present invention to provide an antimicrobial microencapsulated fabric finish composition, comprising of:
Neem extract—25% v/v;
Azadirachtin—5.0% v/v;
Formaldehyde—melamine resin— 1; 1(w/w) and
Binder—2-4% v/v,
   wherein the composition is a spray dried powder of particle of size 5 mm to 20 mm

It is another aspect of the present invention to provide an antimicrobial microencapsulated fabric finish composition, wherein the finish agent is spray dried powder.

It is another aspect of the present invention to provide an antimicrobial microencapsulated fabric finish composition, wherein the binder is selected from salts of polyacrylic acid, Styrene Acrylic copolymer binder, polyurethane dispersions, polyethylene emulsions and combinations thereof.

It is another aspect of the present invention to provide a method for preparation of antimicrobial microencapsulated fabric finish composition, comprising the steps of:
preparation of polymeric shell material:
   dissolving polymeric resin comprising formaldehyde and melamine in water (1:1), by
   dissolving 400 grams of formaldehyde and 400 grams of melamine in 100 ml of water;
   addition of binder polyacrylic acid (40 grams to water);
   preparation of neem extract/azadirachtin dispersion comprising addition of 500 grams of neem extract and 100 grams of Azadirachtin in 2000 ml deionised water to provide 25% concentration of neem and 5% concentration of azadirachtin;
   dispering neem extract with 25% concentration and azadirachtin 5% in deionized water and stirring for 60 minutes;
   adding of polymeric shell material (100 ml) into the neem extract (200 ml) in a ratio of 1:2-azadirachtin dispersion and stiffing at 1200 rpm for 30 minutes; and evaporation of liquid from the sample droplets to yield a spray dried microcapsules of the anti-microbial composition.

It is another aspect of the present invention to provide a method for preparation of antimicrobial microencapsulated fabric finish agent, wherein the binder is selected from salts of polyacrylic acid, Styrene Acrylic copolymer binder, polyurethane dispersions, polyethylene emulsions and combinations thereof.

It is another aspect of the present invention to provide a method for preparation of antimicrobial microencapsulated fabric finish agent, wherein the ratio of polymeric shell material to the neem extract-azadirachtin dispersion is 1:2.

It is another aspect of the present invention to provide a method for preparation of antimicrobial microencapsulated fabric finish agent, wherein the parameters for evaporation of liquid on sample are drying air temperature 120° C., and outlet drying temperature of 90° C.

It is yet another aspect of the present invention to provide a method of coating the fabric with an anti-microbial composition of claim 1, comprising steps:
dissolving microencapsulated anti-microbial agent in deionized water;
dissolving binder in water (20% solution or 3 kgs in 15 l of water) at a temperature of 80° C.; mixing of the microencapsulated anti-microbial agent in the binder solution (3 kgs) to the binder solution at 80° C.;
addition of softener 1 to 2% on the weight of the fabric (cationic/silicone softener) and
running for 20 minutes at 40 degree Celsius and draining; and
unloading of the and hydro extracted before drying,
   wherein the dosing of the agent is done for 20-30 minute interval period, ph is maintained at 6 to 6.5 by adjusting the addition of glacial acetic acid solution to the bath, followed by running the fabric for 30 minutes at 40° C. and drain, and wherein the concentration of the anti-microbial composition and binder for coating of fabric is 3% w/w.

### DETAILED DESCRIPTION OF THE INVENTION

Biological Source: Neem fruits and flower from Azadirachta indica.

Geographical Origin: Neem fruits and flower from Azadirachta indica from Melathooval Village, Kelathooval (post), Mudukulathur Taluk, Ramnad District, Tamil Nadu,. India. Pin-623706.

The present invention generally relates to fabric finishing. More particularly, it relates to a microencapsulated natural antimicrobial fabric finishing agent for fabric, comprising of neem extract and azadirachtin.

Neem oil is a common pest and insect repellent. It is a strong anti-oxidant and an anti-inflammatory. It also has anti-microbial effect and effective against many strains of bacteria, fungi and viruses. The encapsulated form of neem oil and its combination with Azadirachtin make it very powerful and deliverable onto the different substrates like textiles.

According to the present invention, the microencapsulated fabric finishes agent composition. The microencapsulated composition comprises of 25% neem extract v/v and 5% azadirachtin v/v core coated with resin and binder. Microencapsulation typically consists of the preparation of an emulsion followed by the formation of a polymer shell by interfacial or induced phase-separation polymerization, resulting in core—shell structures. In an embodiment of the present invention the core comprises of neem extract consisting 25% neem extract v/v and 2% azadirachtin v/v. Shell materials suitable for the encapsulation of small-molecular weight molecules are typically polymers such as polyamide, polyurea, polyurethane and urea/melamine—formaldehyde.

According to an embodiment of the present invention the shell material comprises of resin selected from formaldehyde: melamine in a ratio of 1:1. For all purposes in various embodiments of the present invention the concentration of the resin is Formaldehyde: Melamine: water is 40%: 40%: 20% by w/v.

According to the aspect of the present invention the binders/additives are selected from salts of polyacrylic acid, Styrene Acrylic copolymer binder, Polyurethane dispersions, Polyethylene emulsions and combinations thereof.

A preferred embodiment of the present invention discloses an antimicrobial composition as a fabric finish. The antimicrobial composition comprises of Microencapsulated Neem Extract with 25% Active content with 5% Azadirachtin. Another embodiment of the present invention relates to a process of finishing of the fabric with antimicrobial composition comprises of the steps: desizing of the fabric, Scouring and half Bleaching, neutralization, dyeing after treatment, finishing with an antimicrobial composition, softening, and finishing, wherein the antimicrobial composition comprises of extract of Azadirachta indica.

Preparation of Neem Extract:

The Neem extract comprises of powder extract from Leaves of Azadirachta indica. Neem leaves were collected from 10-12 years Neem Trees, Neem leaves were sterilized with 1% Hypo (Sodium hypochlorite solution) and washed three times with distilled water. Washed Neem leaves were put into the mortar and grinned well to make it as a powder. 5-6 liters of distilled water were added to the grinned Neem powder and make it as a paste. The paste/mixture are kept aside for 3 to 5 days. Strainer was used to filter the leaves from the mixture and the clear extract used as a raw material for Micro encapsulation. This extract is dry powder extract of Neem leaves.

Azadirachtin is an extract of fruit from neem tree and controls the growth regulator that controls the metamorphosis process as the insect passes from the lava stage to pup stage. Azadirachtin is obtained from neem seeds by extraction method.

Azadirachtin is an extract of fruit from neem tree and controls the growth regulator that controls the metamorphosis process as the insect passes from the lava stage to pup stage. Azadirachtin is obtained from neem seeds by extraction method. Steps given below.

Steps as below.

Neem seeds from 10 to 12 years old trees (Azadirachta indica) were collected, followed by removal of Neem oil content from seeds by means of pressing /grinding of Neem seeds. Extraction of de-oiled neem seeds with a polar organic solvent like water, methanol and N propanol in which Azadirachtin is soluble and the same time polysaccharides and proteins are in substantially soluble to form an organic solution of Azadirachtin and the remaining oil portion. Partitioning the organic solution against water to form an aqueous solution of Azadirachtin and remaining oil. Evaporation of organic solvent to form an Azadirachtin rich powder of 98 to 100% concentration.

Preparation of emulsions: The neem encapsulation procedure is emulsion polymerisation. Microencapsulation is a process of enveloping the core material e.g. bioactive components like neem extract, neem seed oil, azadirachtin etc. in a protective shell material. The capsule/ shell are based on amino/amido resin. The additive is polymeric based on polyacrylic acid for better adhesion.

Steps involved in preparation of the microcapsules of the anti-microbial composition according to embodiments of the present invention:

Preparation of emulsions: Shell emulsions according to an embodiment of the present invention were prepared by using amino/amido resin.

Each polymeric resins, is prepared from shell emulsions prepared by using a technique of condensation reaction of formaldehyde and melamine. The final resin is dissolved in water and then poly acrylic acid was poured in to the micro emulsion solution.

In another container neem extract with 25% concentration and azadirachtin (5%) were dispersed in 100 ml of deionized water and stirred well for 60 minutes.

25 gms of neem powder dispersed in deionized water 100 ml with 5 gms of the above azadirachtin powder dispersed in deionized water 100 ml, providing a concentration of 25% w/v and 5% w/v respectively. 200 ml of neem extract prepared such is used for preparation of microcapsules.

Addition of 100 ml of polymeric shell material into the 200 ml of neem extract/azadirachtin dispersion, the mixture was stirred well at 1200 rpm for 30 minutes. In all preparations neem extract to shell material was maintained at 2:1. Neem extract 200 ml neem and 100 ml of polymeric shell material solution.

The prepared emulsion was spray dried with emulsion being pump fed into dryer prior to being atomized in the drying chamber. Drying of the emulsion to yield microcapsules was achieved by evaporation of liquid from the sample droplets occurred on contact with drying air temperature at 120° C. with an outlet drying temperature of 90 degree Celsius. The obtained dry powder by spray drying was kept in sealed bags for further applications.

Finishing Mechanism: Three finishing mechanisms may be recognized based on the antimicrobial function performed by the particular finish on the textile. These mechanisms include control-release, regeneration and barrier-block. The first two finishing mechanism having problems in usage. The problems with control release mechanism are its durability after laundering and leaching of antimicrobial from fabric which can come in contact with wearer's skin. These agents have the potential to affect the normal skin, which could lead to extreme skin irritation and allergy issues. These leachate will cause serious issues in sewage waste water treatment causing harmful effects microorganisms. These problems can occur with the fabric using a regenerate mechanism by fixing on the surface of the fibre by binder. Microencapsulated Neem exhibits good antimicrobial property. Neem starts coming out from the fabric surface gradually while rubbing. As these agents require chlorine bleach to activate its antimicrobial properties after laundering. Chlorine bleach not only damages the cotton fabric but is also harmful for human skin. Barrier-block mechanism does not pose the problems associated with other two methods. These agents are bonded on fabric surface and do not leach, thereby killing the bacteria that come in contact with the fabric. The present invention, Antimicrobial property of towels treated with neem Extract along with Azadirachtin.

Results are extremely good and durable upto 50 HL.

According to an embodiment of the present invention there is provided a method of finishing the fabric: In general terry towel/woven fabrics/bed linens and sheetings are being processed as per the below sequence:

Grey fabric desizing, scouring, and half-bleaching with hydrogen peroxide, dyeing, after treatment/post washing, neutralization and finishing with softener.

Machines used are soft flow dyeing machines and jiggers.

Neem based microcapsule solution is applied by exhaustion method in the last bath of textile fabric processing in soft flow machines and jiggers.

Method of application.

Soft flow Dyeing machine.

100 Kgs of fabric.

500 Litres of water.

Dosage: Micro encapsulated Neem solution 3% on weight of fabric-3 kgs for every 100 kgs of fabric

Binder 3% on weight of fabric—3 kgs per every 100 kgs of fabric.

Dissolve the binder 3 kgs in 15 litres of hot water (20% w/v solution) at 80° C. and by mixing thoroughly for 5 Min.

Add the Microencapsulated Neem (3 kgs) into the Hot water/binder solution and mix well for 5 min

Add this solution to the dosing tank of the soft flow dyeing machine and dose the solution to the soft flow machine with fabric to be finished and run the machine for 30 min at pH 6-7.

According to another embodiment of the present invention, there is provided a method of preparation of finish using the microencapsulated composition, for coating the fabric.

Microencapsulated neem solution (viscous liquid); 2 to 5.0% on weight of the fabric. Binder (gel)—2—4% on weight of the fabric and dissolve in hot water at 70 degree Celsius.

Preferred embodiments of the present invention disclose a concentration of 3% of microencapsulated Neem and 3% of binder w/w for fabric weight.

Add Neem based microencapsulate solution to the hot water (5 times of binder weight) having binder and mix well thoroughly. This microencapsulated neem/binder solution is ready got finishing application.

### Example 1

Wt of neem microcapsules—30% w/v (25% neem extract 5% azadirachtin)

Volume of water to give microcapsule dispersion.

Addition of 1 liter of binder solution to 5 lts of hot water to yield a binder solution.

Addition of 1 litre of microcapsule solution to 6.0. lts of the binder solution.

pH of the microcapsule solution is 6-7.

According to another embodiment of the present invention, there is provided a method of finishing / application of microencapsulated composition:

Add the microencapsulated neem/binder in the dosing tank of soft flow dyeing machines. Start dosing for 20—30 minute interval period. Maintain the pH of the fabric bath at 6 to 6.5 by adjusting the addition of glacial acetic acid solution to the bath.

Run the fabric for 30 minutes at 40 degree Celsius and drain. Neem microencapsulated solution will react with cotton and got fixed on the pores of the cotton. Add softener 1 to 2% on the weight of the fabric (cationic/silicone softener) and run 20 minutes at 40 degree Celsius and drain. The fabric is unloaded from the soft flow dyeing machine and hydro extracted before going for drying.

Method of drying:

Drying is normally carried out in batch tumbler or continuous tumble dryer or stinter and dried at 120 to 130 degree Celsius, No high temperature curing is required.

Not observed any drop in absorbency for terry and woven fabric.

Device/means for finishing the fabric using the composition: Microencapsulated neem is applied in the soft dyeing machine/jigger and thus treated fabric is finished (dried) in tumbler dryer and stinter drying machine. Drying temperature is 120—130 degree Celsius and high temperature curing is not required for durability.

The microencapsulated composition is in semi-viscous liquid form. Binder is in gel form. Anti-microbial efficacy test Experimental studies conducted to test the stability of the antimicrobial finish in the fabric:

Terry fabrics/woven terry fabrics of dyed and full white were used for trial experiments and testing.

Neem treated terry fabric was washed in top loading washing machine as per care label instruction.

Home laundering washing as per normal wash cycle displayed in the top loading washing machine. Home laundered pieces were tested for the presence of residual microencapsulated neem by antimicrobial test—AATCC-100-2012 for both gram positive and gram negative bacteria. External lab report showed the presence of neem microencapsule even after 50 home laundering by exhibiting 94.5% antimicrobial efficiency.

Test method:

Evaluation of antimicrobial activity AATCC 100-2012

Home laundering as per wash care instruction in top loading whirl pool washing machine.

Test inoculums;

1. Staphylococcus aureus ATCC 6538 (1.80×10⁵ CFU/ml)

2. Klebseiella pneumonia ATCC 4352 (1.90×10⁵CFU/m1)

Additional Test information:

1. Sample size: 48 mm discs

2. No. of swatches used: 2

3. Method of Sterilization of sample: Free steaming

4, Inoculum carrier: Phosphate buffered water

5. Neutralizer: DE Broth

Results:

Towel Sample swatches in contact with individual test cultures for 24 hrs at 37° C. showed the following results:

| | | No. Of bacteria per sample | | |
|---|---|---|---|---|
| | | (CFU/Sample) | | |
| | | Inoculated | Inoculated | |
| | | sample at 0 | sample at 24 | Percentage reduction |
| Sample identification | Test culture | hours (B) | hours (A) | of microorganisms (R) |
| Neem treated towel | Staph.aureus | 1.98 × 10⁵ | <10 | >99.99 |
| treated | K. pneumonia | 2.06 × 10⁵ | <10 | >99.99 |
| Neem treated towel | Staph.aureus | 1.93 × 10⁵ | 1.06 × 10⁴ | 94.50 |
| treated and 50 home | K. pneumonia | 2.04 × 10⁵ | 1.82 × 10⁴ | 91.01 |
| laundered | | | | |

Remarks:

1. CFU: Colony forming unit=No. of microorganisms

2. Percentage reduction of microorganisms (R)=100 (B-A/B)

Interpretation:

Towel sample labelled as neem treated towel—treated has shown >99.99% and >99.99% antimicrobial activity; Treated and 50 home laundered has shown 94.50% and 91.01% antimicrobial activity towards Staphylococcus aureus and Klebsiella pneumonia respectively when analysed as per AATCC 100-2012 test method.

I claim:

1. An antimicrobial microencapsulated fabric finish composition, comprising of:
Neem extract—25% v/v;
Azadirachtin—5.0% v/v;
Formaldehyde—melamine resin—1; 1(w/w); and
Binder—2-4% v/v,
wherein the composition is a spray dried powder of particle of size 5 mm to 20 mm

2. The antimicrobial microencapsulated fabric finish composition as claimed in claiml, wherein the finish agent is spray dried powder.

3. The antimicrobial microencapsulated fabric finish composition as claimed in claiml, wherein the binder is selected from salts of polyacrylic acid, Styrene Acrylic copolymer binder, polyurethane dispersions, polyethylene emulsions and combinations thereof.

4. A method for preparation of antimicrobial microencapsulated fabric finish composition, comprising the steps of:
preparation of polymeric shell material:
dissolving polymeric resin comprising formaldehyde and melamine in water (1:1), by
dissolving 400 grams of formaldehyde and 400 grams of melamine in 100 ml of water;
addition of binder polyacrylic acid (40 grams to water);
preparation of neem extract/azadirachtin dispersion comprising addition of 500 grams of neem extract and 100 grams of Azadirachtin in 2000 ml deionized water to provide 25% concentration of neem and 5% concentration of Azadirachtin;
dispersing neem extract with 25% concentration and azadirachtin 5% in deionized water and stirring for 60 minutes;
adding of polymeric shell material (100 ml) into the neem extract (200 ml) in a ratio of 1:2-azadirachtin dispersion and stiffing at 1200 rpm for 30 minutes; and
evaporation of liquid from the sample droplets to yield a spray dried microcapsules of the anti-microbial composition.

5. The method for preparation of antimicrobial microencapsulated fabric finish agent claimed in claim 4, wherein the binder is selected from salts of polyacrylic acid, Styrene Acrylic copolymer binder, polyurethane dispersions, polyethylene emulsions and combinations thereof.

6. The method for preparation of antimicrobial microencapsulated fabric finish agent claimed in claim 4, wherein the ratio of polymeric shell material to the neem extract-azadirachtin dispersion is 1:2.

7. The method for preparation of antimicrobial microencapsulated fabric finish agent claimed in claim 4, wherein the parameters for evaporation of liquid on sample are drying air temperature 120° C., and outlet drying temperature of 90° C.

8. A method of coating the fabric with an anti-microbial composition of claim 1, comprising steps:
dissolving microencapsulated anti-microbial agent in deionized water;
dissolving binder in water (20% solution or 3 kgs in 15 1 of water) at a temperature of 80° C.;
mixing of the microencapsulated anti-microbial agent in the binder solution (3 kgs) to the binder solution at 80° C.;
addition of softener 1 to 2% on the weight of the fabric (cationic/silicone softener) and running for 20 minutes at 40 degree Celsius and draining; and unloading of the and hydro extracted before drying,
wherein the dosing of the agent is done for 20—30 minute interval period, ph is maintained at 6 to 6.5 by adjusting the addition of glacial acetic acid solution to the bath, followed by running the fabric for 30 minutes at 40° C. and drain, and wherein the concentration of the anti-microbial composition and binder for coating of fabric is 3% w/w.
